(19) United States
(12) Patent Application Publication
(10) Pub. No.: US 2024/0278464 A1
(43) Pub. Date: Aug. 22, 2024

(54) METHOD FOR MANUFACTURING A SENSOR FOR A MOTOR VEHICLE

(71) Applicant: Continental Automotive Technologies GmbH, Hannover (DE)

(72) Inventors: Hervé Contet, Lamasquère (FR); Martin Throm, Toulouse (FR); Marco Benner, Biedenkopf (DE)

(21) Appl. No.: 18/439,090

(22) Filed: Feb. 12, 2024

(30) Foreign Application Priority Data
Feb. 21, 2023 (FR) 2301563

(51) Int. Cl. B29C 45/14; B29L 31/34; G01D 11/24; G01D 11/30

(52) U.S. Cl. CPC B29C 45/14639; G01D 11/245; G01D 11/30; B29L 2031/3406

(57) ABSTRACT

A method for manufacturing a sensor for a motor vehicle. The method includes the steps of placing leads on a support, positioning a mold, injecting overmolding material into the mold so as to obtain a sealing housing comprising a body and a hatch, the hatch being formed adjacently to the belt in the plane of the lower face of the body by being connected to the joining lateral face by at least one portion of overmolding material, called “connecting portion”, removing the mold, applying a force to the hatch in order to insert it by sliding and close the lower face of the sealing housing, filling the internal space of the sealing housing with a sealing gel in order to seal the leads, and externally overmolding the entire sensor.

### CROSS REFERENCE TO RELATED APPLICATION

This application claims priority to French Patent Application 2301563, filed Feb. 21, 2023, the contents of such application being incorporated by reference herein.

### FIELD OF THE INVENTION

The present invention relates to the field of sensors for a motor vehicle and more particularly to a sensor and to a method for manufacturing such a sensor. The invention notably aims to improve the sealing of existing sensors.

### BACKGROUND OF THE INVENTION

In a known manner, a motor vehicle comprises measurement sensors for, for example, measuring the speed of rotation or the angular position of a drive shaft such as a crankshaft or a camshaft or detecting the speed of rotation of a gearbox.

Still in a known manner, these sensors operate in association with a target fastened to the shaft for which a parameter is desired to be measured. The target is, for example, in the form of a toothed wheel, the teeth of which vary an electromagnetic field generated by a magnet mounted in the sensor. The magnetic field variations are detected by sensitive elements, called measurement cells, of the sensor.

According to a known manufacturing method, the sensor is manufactured in several steps. First of all, an integrated circuit is overmolded with a polyepoxide material, commonly called “epoxy”, on a metal leadframe comprising leads, then the assembly is positioned in a mold, or in a pre-molded subassembly, and a magnet is potentially positioned or overmolded relative to the integrated circuit. The assembly is assembled, and a final overmolding is applied allowing only the leads to project out in order to seal the sensor while at the same time forming an electrical connector of the sensor to the vehicle and a member for fastening the sensor, for example of the fastening ring type.

In certain cases, the sensor may be in contact with a liquid, for example by being immersed in an oil bath or in a mist of oil droplets.

Due to the difference in the thermomechanical properties of the metal of the leads and of the material of the overmolding elements, spacings may form during the overmolding or, upon wear, between these elements and then allow an infiltration of liquid.

The sealing of the final overmolding is therefore important, notably in order to prevent the liquid from penetrating inside the sensor along the electrical leads and thus damaging the integrated circuit and/or the measurement cells, notably with the formation of dendrites that may create a short-circuit.

A known solution consists in disposing a receptacle around the leads and depositing a gel inside said receptacle such that said gel surrounds the leads to provide sealing. However, the placement of the receptacle and the introduction of the gel around the leads can prove to be complex and time-consuming and the sealing between the sealing housing and the receptacle may prove difficult to ensure.

There is therefore a need for a solution that makes it possible to at least partially remedy these drawbacks.

### SUMMARY OF THE INVENTION

To this end, an aspect of the invention firstly relates to a method for manufacturing a sensor for a motor vehicle, comprising an integrated circuit connected to cells for measuring a parameter, and connection leads electrically connected on one side to the integrated circuit and intended to be connected on the other side to an electrical network of the vehicle, the method comprising the steps of:
a. —placing the connection leads on a support,
b. —positioning a mold around the connection leads, said mold being configured to surround the connection leads,
c. —injecting overmolding material into the mold so as to obtain a sealing housing comprising a body and a hatch, said body being in the form of a belt of material of parallelepipedal shape comprising four solid faces delimiting an internal space, an open lower face and an open upper face of the sealing housing, the connection leads of the sensor passing through two opposite solid faces of the body, respectively referred to as “front” face and “rear” face, the two other faces of the body being a solid lateral face and a lateral face referred to as “joining” lateral face, the hatch being formed adjacently to the belt in the plane of the lower face of the body by being connected to the joining lateral face by at least one portion of overmolding material, called “connecting portion”,
d. —removing the mold,
e. —applying a force to the hatch so as to detach said hatch from the at least one connecting portion and so as to cause said hatch to slide in order to insert it by sliding through the joining face and close the lower face of the sealing housing,
f. —filling, via the upper face of the sealing housing, the internal space of the sealing housing with a sealing gel in order to seal the connection leads,
g. —externally overmolding the entire sensor.

This method makes it possible to obtain a sealing housing filled with gel which makes it possible to seal the sensor better than a single block of reflow fins as known in the prior art, since the gel is less sensitive to deformations caused by an increase in the temperature of the material and is therefore less susceptible to the creation of faults at the connection leads, thus making it possible for the liquid to rise up to the measurement cells. In addition, at least one row of reflow fins is disposed around the sealing housing to ensure the sealing of this subassembly between the molding of the sealing housing and the final overmolding of the sensor. The connecting portions between the body of the sealing housing and the hatch may also serve as supply channel for the molding plastics material for the hatch during the injection, thus making it possible to avoid putting a second injection point in the region of this hatch. Furthermore, this solution dispenses with a hinge-type connecting solution which imposes a restriction of use of glass-fiber-filled materials, and also difficulties in having precise assembly operations. It also dispenses with the use of clips for holding the hatch in the sealing housing.

Preferably, the step of injecting overmolding material of the sealing housing comprises the formation, on the lower face, of at least one support block of the hatch. This block supports the hatch after the latter has been slid to close the sealing housing in a position for shutting off the lower face.

Advantageously, the at least one block is a distal block connecting the front and rear faces, and the solid lateral face, opposite the joining face. This form of block connected to three walls enables solid bearing of the hatch during its fastening.

In addition to this distal block, the step of injecting overmolding material advantageously comprises the formation, on the lower face, of two proximal blocks facing one another, one extending from the lower edge of the front face and the other from the lower edge of the rear face.

Preferably, the proximal blocks are positioned between the middle of the front and rear faces and the joining face, and are offset from the connection leads so as to not be immediately below them for the molding of the sealing housing. These blocks support the hatch, notably in its median part.

Preferably, the step of injecting overmolding material also comprises the formation, on each of the front and rear faces, of a holding block extending from said front and rear face in the internal space, and of a holding and sealing boss at the bottom of the joining face. These blocks are positioned above the location of the hatch to apply pressure on the top of the hatch once the latter is inserted in the body in order to block it in the closed position. The holding and sealing boss has the same function at the bottom of the joining face. The function of these devices is to ensure the sealing of the sealing housing at the distal block on the side of the solid lateral face and also at the joining lateral face, thus allowing the gel to be deposited in the sealing housing.

Advantageously, these holding blocks are disposed facing one another.

Also advantageously, these holding blocks are situated between two connection leads so as to not be immediately below them for the molding of the sealing housing.

Preferably, the step of injecting overmolding material comprises the formation of lateral sliding grooves and ribs along the lateral edges of the hatch. The edges slide on the blocks of the lower face. As the hatch extends along a longitudinal axis parallel to the direction of the insertion of the hatch, these lateral edges of the hatch are those parallel to the longitudinal axis of the hatch along which it is inserted into the sealing housing. The outer edges of these lateral ribs are squashed slightly during the insertion of the hatch into the sealing housing all the way along the front and rear faces thus ensuring the sealing of the sealing housing, thus allowing the gel to be deposited in the sealing housing.

Preferably, the step of injecting overmolding material comprises the formation of a depression centered on the upper surface of the hatch. Thus, when the sealing housing is filled with gel, the latter fills this depression, and, after solidification, this filling participates in holding the hatch in the closed position. In addition, the molding of the body and of the hatch does not require additional compartments in the molding tool, but solely a lower cavity and an upper cavity.

An aspect of the invention also relates to the mold used for the shaping of the sealing housing by the method, comprising a body and a hatch, said body being in the form of a belt of material of parallelepipedal shape comprising four solid faces delimiting an internal space, an open lower face and an open upper face of the sealing housing, the connection leads of the sensor passing through two opposite faces respectively referred to as “front” face and “rear” face, the hatch being formed adjacently to the belt in the plane of the lower face of the body by being connected to a solid face of the body by at least one portion of overmolding material, called “connecting portion”, application of a force to the hatch so as to detach said hatch from the at least one connecting portion and so as to cause said hatch to slide in order to insert it by sliding and thus close the lower face of the sealing housing.

An aspect of the invention also relates to a sensor for a vehicle thus obtained by the method, comprising a connector for electrical connection to the vehicle and a member for fastening to an element of said vehicle.

An aspect of the invention also relates to a motor vehicle comprising a sensor obtained by the method thus described.

### BRIEF DESCRIPTION OF THE DRAWINGS

Other features and advantages of aspects of the invention will become more clearly apparent on reading the following description. This description is purely illustrative and should be read with reference to the accompanying drawings, in which:

FIG. 1 schematically illustrates a perspective view of one embodiment of an assembly comprising an overmolding of a sealing housing, hatch in the open position, on metal connection leads and an overmolding of an integrated circuit and of measurement cells connected to said connection leads.

FIG. 2 is a perspective view from above of the sealing housing in FIG. 1, hatch in the open position.

FIG. 3 is a perspective view from below of the sealing housing in FIG. 1, hatch in the open position.

FIG. 4 is a perspective view from above of the sealing housing in FIG. 1, hatch in the closed position.

FIG. 5 is a perspective view from below of the sealing housing in FIG. 1, hatch in the closed position.

FIG. 6 is a view in section of the sealing housing in FIG. 1 after its overmolding, in its mold.

FIG. 7 schematically illustrates a perspective view of one embodiment of an assembly comprising an overmolding of a sealing housing filled with gel, hatch in the closed position, on metal connection leads and an overmolding of an integrated circuit and of measurement cells connected to said connection leads.

FIG. 8 schematically illustrates the sensor in FIG. 1 after the sealing operation and a final overmolding of the sensor.

FIG. 9 schematically illustrates one embodiment of the method according to an aspect of the invention.

### DETAILED DESCRIPTION OF THE PREFERRED EMBODIMENTS

The sensor obtained by the method according to an aspect of the invention is intended to be mounted in a motor vehicle. The sensor may be of any type. For example, the sensor may be a position sensor or speed sensor of a drive shaft such as a crankshaft or a camshaft, of a gearbox or any other suitable shaft.

FIG. 1 illustrates an example of an intermediate form of the sensor 1 during its manufacture in one embodiment of the method according to the invention.

### Sensor 1

The sensor 1 comprises two connection leads 10, a support overmolding 20 and a sealing housing 30.

### Connection Leads 10

The connection leads 10, of rectangular section, each comprise a free end 101 intended to be electrically connected to an electrical network of the vehicle (not shown), and a connection end 102 overmolded in a support overmolding 20.

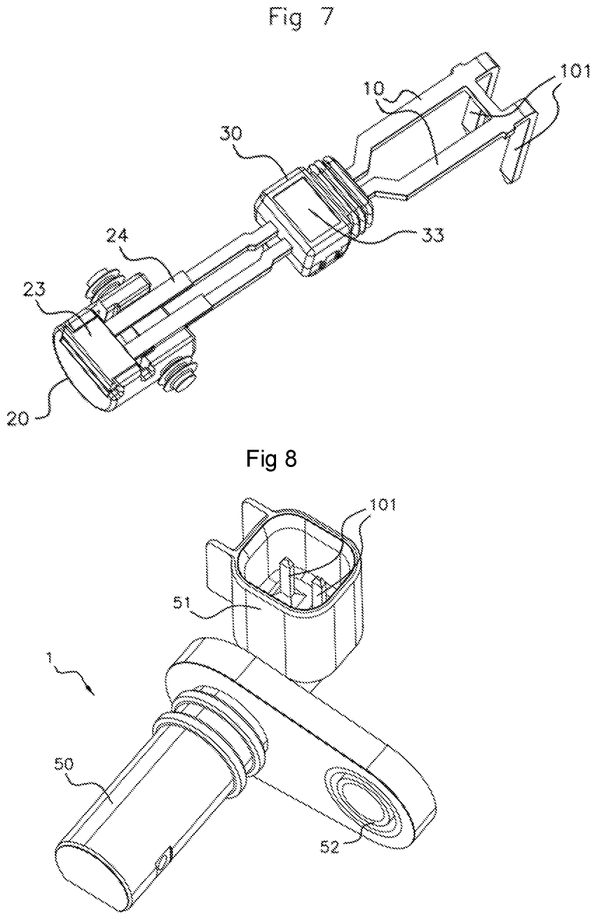

Each connection lead 10 comprises a connector 103 for electrically welding said connection lead 10 with a connection tab 24 of the integrated circuit 23 (visible in FIG. 7) of the sensor 1.

In the embodiment shown in FIG. 1, the two connection leads 10 are initially connected so as to simplify the molding step and are subsequently punched so as to be separated.

### Support Overmolding 20

Still with reference to FIG. 1, the support overmolding 20 is molded around the connection ends 102 of the connection leads 10. In a variant, the connection leads 10 could be attached to the support 20.

In this non-limiting example, the support overmolding 20 delimits a cavity 21 intended to receive a magnet (not visible) and a receiving surface 22 of an integrated circuit 23 (visible in FIG. 7) of the sensor 1.

### Sealing Housing 30

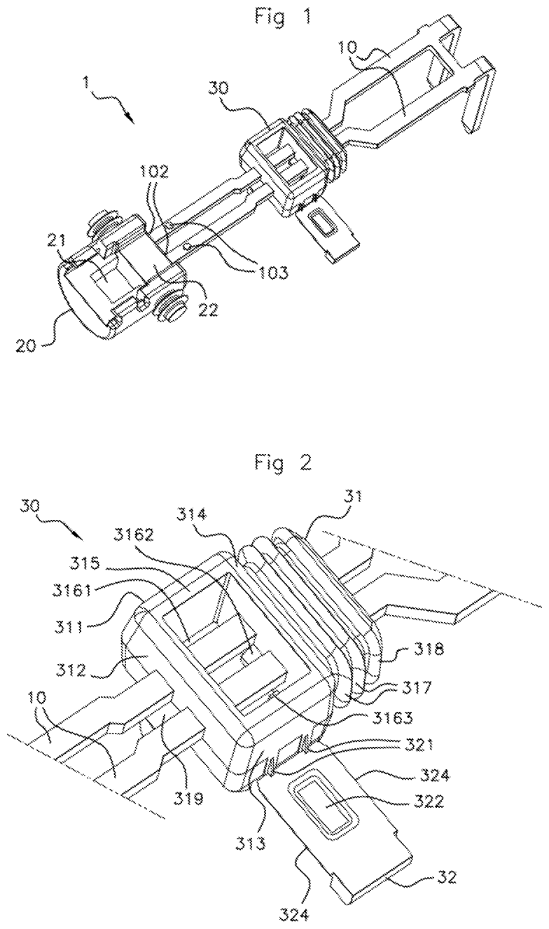

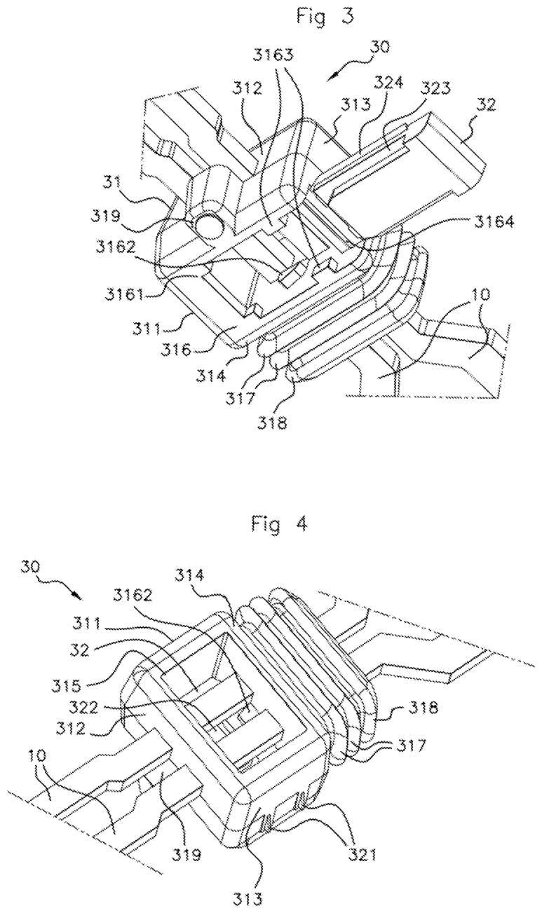

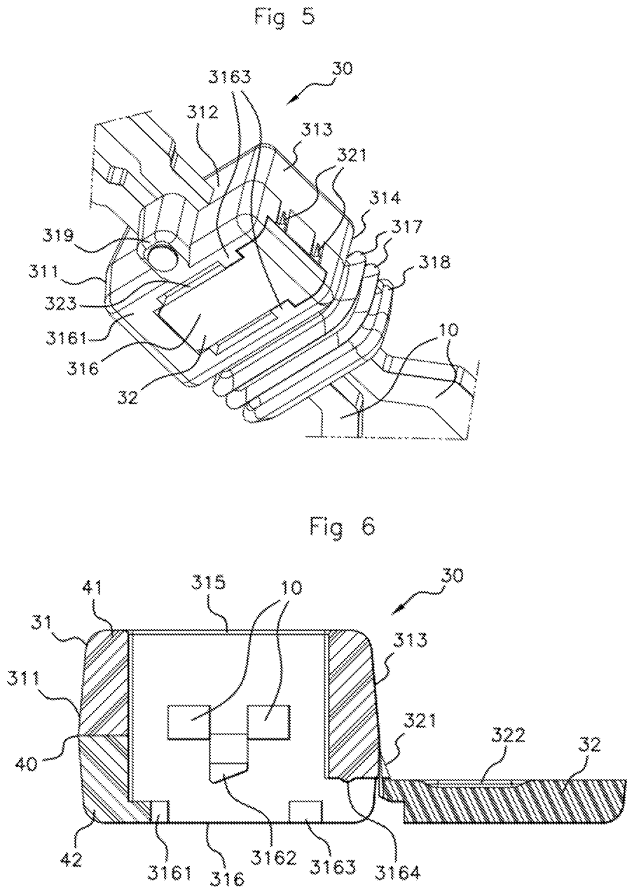

With reference to FIGS. 2 to 6, the sealing housing 30 comprises a body 31 and a hatch 32.

### Body 31

The body 31 is of parallelepipedal shape having six faces: a solid lateral face 311, a face 312 referred to as “front” face, a lateral face referred to as “joining” face 313, a face 314 referred to as “rear” face opposite the front face 312, a face referred to as “upper” face 315 and a face referred to as “lower” face 316.

The opposite front 312 and rear 314 faces are passed through by the connection leads 10.

The front face 312 has an injection rim 319 for the overmolding.

The rear face 314 is extended in the direction of the connection leads 10 by a set of reflow fins 317 which are also passed through by said connection leads 10, limited by the rear face 314 and by a low protective wall 318 of these reflow fins 317 during the final overmolding.

The upper face 315 does not have any overmolding material (i.e. is bypassed) in order to allow the sealing housing 30 to be filled with the gel 33.

The lower face 316 is bypassed and is configured to receive the hatch 32. Material is still present on this face, in the form of a distal block 3161 which extends from the bottom of the solid lateral face 311, two holding blocks 3162, one extending from a section of the bottom of the front face 312 and the other from the rear face 314, and two proximal blocks 3163, one extending from a section of the interior of the front face 312 and the other from the rear face 314. A holding and sealing boss 3164 is present at the bottom of the joining face 313.

The joining face 313 is connected to the hatch 32 by the connecting portions 321.

### Hatch 32

The hatch 32 comprises the connecting portions 321, a depression 322, sliding grooves 323 and the lateral ribs 324 on either side of the hatch 32 in the direction of sliding in the body 31 of the sealing housing 30.

### Gel 33

The gel 33 is poured into the sealing housing 30 after the latter is closed.

### Mold 40

FIG. 6 shows the inner impressions of the upper part 41 and the lower part 42 of the mold 40.

### Final Overmolding 50

With reference to FIG. 8, the sensor 1 comprises a final overmolding 50 forming the outer envelope of the sensor.

The sensor 1 with final overmolding 50 also comprises an electrical connection connector 51 configured to connect the free ends 101 of the connection leads 10 to the electrical circuit of the vehicle, and a fastening member 52 which fastens the sensor 1 in the vehicle.

### Example of an Embodiment

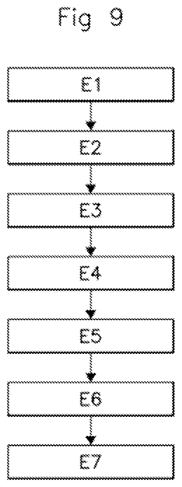

The sealing method is shown in FIG. 9.

In a step E1, the connection leads 10 are placed on a holding support. Each connection lead 10 has a free end 101 and a connector 103 at the connection end 102.

In a step E2, the upper part 41 and the lower part 42 of the mold 40 are positioned on the connection leads 10 in order to clamp them. The inner enclosure of the mold 40 is configured to form the sealing housing 30, comprising the body 31 and the hatch 32.

The upper part 41 of the mold 40 and the lower part 42 are each in contact with the segment of the connection leads 10 which is inside the sealing housing 30.

In a step E3, the mold is filled with material which takes the shape of the sealing housing 30. The injection rim 319 for the overmolding has been studied and positioned such that it is dimensioned so as to be able to correctly supply the housing 31, without deforming the leads 10.

After the step E4 of removing the two parts of the mold 40, the sealing housing 30 is overmolded on the connection leads 10. The connection leads 10 pass through the front face 312 and the rear face 314, whereas the hatch 32 is secured to the body 31 by the connecting portions 321.

In a step E5, the connecting portions 321 are reduced by the insertion tool, since these connecting portions 321 are cut by this same tool under the force of their insertion, and the hatch 32 closes the lower face 316 of the body 31 of the sealing housing 30.

Preferably, the hatch 32 is slid into the lower face 316. The sliding grooves 323 of the hatch are inserted under the joining face 313 of the body 31 between the holding blocks 3162 and the proximal blocks 3163, and above the distal block 3161 present on the lower face 316. This system of blocks makes it possible to block the hatch 32 and seals the sealing housing 30.

The holding and sealing boss 3164 on the lower edge of the joining face 313 also makes it possible to bear against the hatch 32 in order to seal the sealing housing 30 and hold the hatch 32 in position on the lower face 316 during the rest of the operations of the sealing method. The outer edges of the lateral ribs 324 are squashed slightly during the insertion of the hatch 32 into the body 31 all the way along the front face 312 and the rear face 314 thus ensuring the sealing of the sealing housing 30, thus allowing the gel to be deposited in the sealing housing 30.

Preferably, the cutting of the connecting portions 321 and the insertion by sliding of the hatch 32 into the lower face 316 is effected in one go, the force exerted on the hatch 32 being sufficient to sever the connecting portions 321.

Once the hatch 32 is closed, the sealing housing 30 is filled with gel 33 in a step E6. The gel 33 is poured into the space formed by the body 31 closed by the hatch 32 and surrounds the connection leads 10. The gel 33 solidifies around the connection leads 10 and prevents liquid from rising along said connection leads 10. During its solidification, the gel 33 fills the depression 322 in the hatch 32, blocking the latter and ensuring its closure. Once the gel 33 has solidified, the sealing process is ended.

The support overmolding 20 is overmolded in a step E7 at the connection end 102 of the connection leads 10, and a sensor is deposited thereabove and connected to the connectors 103. In a variant, this step could be carried out prior to the molding of the sealing housing 30 or at the same time.

Depending on the nature of the signal measured by the sensor, a magnet may be added to the support overmolding 20 at the location 21.

In another embodiment, the overmolding of the sealing housing 30 and that of the support overmolding 20 are effected simultaneously.

Once the sealing method and the support overmolding 20 have been implemented, the final sensor 1 is obtained after a final overmolding 50 which is effected on the assembly shown in FIG. 1 comprising the connection leads 10, the sealing housing 30 and the support overmolding 20, so as to have a final overmolding 50 which envelops these elements.

The sensor 1 thus obtained is fastened in the vehicle by the fastening member 52.

An aspect of the invention therefore proposes a reliable and effective method for sealing a sensor for a motor vehicle.

1. A method for manufacturing an electronic sensor for a vehicle, said sensor comprising an integrated circuit, comprising cells for measuring a parameter, and connection leads electrically connected on one side to the integrated circuit and intended to be connected on the other side to an electrical network of the vehicle, said method comprising:
placing the connection leads on a support,
positioning a mold around the connection leads, said mold being configured to surround the leads,
injecting overmolding material into the mold so as to obtain a sealing housing comprising a body and a hatch, said body being in the form of a belt of material of parallelepipedal shape comprising four solid faces delimiting an internal space, an open lower face and an open upper face of the sealing housing, the connection leads of the sensor passing through two opposite solid faces of the body, respectively referred to as “front” face and “rear” face, the two other faces of the body being a solid lateral face and a lateral face referred to as “joining” lateral face, the hatch being formed adjacently to the belt in the plane of the lower face of the body by being connected to the joining lateral face by at least one portion of overmolding material, called “connecting portion”,
removing the mold,
applying a force to the hatch so as to detach said hatch from the at least one connecting portion and so as to cause said hatch to slide in order to insert it by sliding through the joining face and close the lower face of the sealing housing,
filling, via the upper face of the sealing housing, the internal space of the sealing housing with a sealing gel in order to seal the connection leads, and
externally overmolding the entire sensor.

2. The method as claimed in claim 1, wherein the step of injecting overmolding material of the sealing housing comprises the formation, on the lower face, of at least one support block of the hatch.

3. The method as claimed in claim 2, wherein the at least one block is a distal block connecting the front and rear faces, and the solid lateral face, opposite the joining face.

4. The method as claimed in claim 2, wherein the step of injecting overmolding material comprises the formation, on the lower face, of two proximal blocks facing one another, one extending from the lower edge of the front face and the other from the lower edge of the rear face, and of a holding and sealing boss at the bottom of the joining face.

5. The method as claimed in claim 1, wherein the step of injecting overmolding material comprises the formation, on each of the front and rear faces, of a holding block extending from said front and rear face in the internal space.

6. The method as claimed in claim 1, wherein the step of injecting overmolding material comprises the formation of lateral sliding grooves and lateral ribs along the lateral edges of the hatch.

7. The method as claimed in claim 1, wherein the step of injecting overmolding material comprises the formation of a depression centered on the upper surface of the hatch.

8. A sensor for a vehicle obtained by the method as claimed in claim 1, said sensor comprising a connector for electrical connection to the vehicle and a member for fastening to an element of said vehicle.

9. A motor vehicle comprising a sensor as claimed in claim 8.

10. The method as claimed in claim 3, wherein the step of injecting overmolding material comprises the formation, on the lower face, of two proximal blocks facing one another, one extending from the lower edge of the front face and the other from the lower edge of the rear face, and of a holding and sealing boss at the bottom of the joining face.
